(19) United States
(12) Patent Application Publication
(10) Pub. No.: US 2004/0107430 A1
(43) Pub. Date: Jun. 3, 2004

(54) Clamp mechanism and information reproducing mechanism

(75) Inventors: Kenji Nakamura, Kawagoe-shi (JP); Yasuhiro Shinkai, Kawagoe-shi (JP); Shigeru Kojima, Kawagoe-shi (JP); Kenji Uchiyama, Kawagoe-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/718,680

(22) Filed: Nov. 24, 2003

(30) Foreign Application Priority Data
Dec. 2, 2002 (JP) P2002-349550

(51) Int. Cl. G11B 17/022

(52) U.S. Cl. 720/707; 720/715

(57) ABSTRACT

There is provided a clamp mechanism for clamping and unclamping an information recording disk to be loaded on a loading plane of a turntable. The clamp mechanism comprises a plurality of holders and a driving device. The holders each holds the disk loaded on the loading plane of the turntable. The driving device drives the holders in both of a holding direction along which the disk is held and an un-holding direction along which the disk is released from being held. At least one of plural holders is configured to press, in a direction parallel to the loading plane, the disk loaded on the turntable.

### BACKGROUND OF THE INVENTION

1. Technical Field

The present invention relates to a clamp to support an information recording medium, such as CD (Compact Disc) and DVD (Digital Versatile Disc), on a turn table and an information reproducing mechanism provided with the clamp mechanism.

2. Related Art

In general, most of information reproducing apparatuses requires a clamp mechanism to hold an information recording medium, such as CD and DVD.

As such a clamp mechanism, a clamp mechanism 1 shown in FIG. 1 has been known. This clamp mechanism 1 has a turntable 2 fit to the rotation shaft of a not-shown rotation motor, so that the turntable rotates in responsive to the rotation of the rotation shaft. Additionally, the clamp mechanism 1 is provided with three chuck claws 3 each formed into a dog-leg shape viewed from a side thereof and arranged at angular intervals of 120 degrees in a central opening formed at the center of the turntable. Turning these chuck claws 3 allows a not-shown disk (i.e., information recording medium) to loaded and unloaded onto and from the turntable 2. This conventional clamp mechanism 1 is further provided with a blade spring 4 to forcibly bias the disk to be aligned in the horizontal direction.

Accordingly, in the conventional clamp mechanism 1, with the blade 4 forcibly biasing the disk in the horizontal direction, the three chuck claws 3 are driven to clip the disk on the turntable 2 so that the disk is located in the horizontal direction.

However, the foregoing conventional clamp mechanism was confronted with a difficulty as follows. Since the blade spring 4 was operated to forcibly bias the disk in the horizontal direction for the alignment, it was necessary to arrange the blade spring 4 besides the three shuck claws 3 to securely support the disk. Thus, both of the number of parts necessary for this clamp mechanism 1 and the number of assembling steps become large, while the clamp mechanism 1 was structured in a complicated way.

### SUMMARY OF THE INVENTION

The present invention has been made with due consideration to the foregoing difficulty, and an object of the present invention is to provide a clamp mechanism capable of securely supporting and aligning an information recording medium, although the number of parts of the clamp mechanism is reduced to have a simplified structure, and an information reproducing mechanism provided with the clamp mechanism.

In order to accomplish the foregoing object, as one aspect of the present invention, there is provided a clamp mechanism for clamping and unclamping an information recording medium to be loaded on a loading plane of a turntable. This clamp mechanism comprises a plurality of holders each holding the information recording medium loaded on the loading plane of the turntable; and a driving device driving the holders in both of a holding direction along which the information recording medium is held and an un-holding direction along which the information recording medium is released from being held; wherein at least one of the plurality of holders is configured to press, in a direction parallel to the loading plane, the information recording medium loaded on the turntable.

It is preferred that the plurality of holders are configured to simultaneously hold and press the information recording medium when the driving device is driven in the holding direction.

Still, it is preferred that the driving device comprises a movable member slidable in a direction perpendicular to the loading plane of the turntable, and a pressing member pressing the plurality of holders so as to release the information recording member from being held, when the movable member is slid in the direction perpendicular to the loading plane to be separated from the loading plane.

As antother asepect of the present inventioin, theres is als o provided an information reproducing mechanism comprising: a turntable having a loading plane on which an information recording medium is allowed to be loaded; and a clamp mechanism for clamping and unclamping the information recording medium loaded on the loading plane of the turntable. The clamp mechanism comprises a plurality of holders each holding the information recording medium on the turntable; and a driving device driving the holders in both of a holding direction along which the information recording medium is held and an un-holding direction along which the information recording medium is released from being held. In this configuration, at least one of the plurality of holders is configured to press, in a direction parallel to the loading plane, the information recording medium loaded on the turntable.

### BRIEF DESCRIPTION OF THE DRAWINGS

Other objects and aspects of the present invention will become apparent from the following description and embodiments with reference to the accompanying drawings in which:

FIG. 1 is a plane view showing a turntable of a conventional clamp mechanism;

FIG. 2 is a plane view showing a disk reproducing mechanism to which a clamp mechanism according to the present invention is applied;

FIG. 3 is an enlarged plane view showing the turntable shown in FIG. 2;

FIG. 4 is an enlarged longitudinal section view showing a clamped state of the clamp mechanism incorporated in the disk reproducing mechanism;

FIG. 5 is an enlarged longitudinal section view showing a transition of the clamp mechanism from its clamped state to its unclamped state;

FIG. 6 is an enlarged longitudinal section view showing the unclamped state of the clamp mechanism incorporated in the disk reproducing mechanism;

FIG. 7 is an enlarged longitudinal section view illustrating the turntable;

FIG. 8 is an enlarged longitudinal section view illustrating a movable member of the clamp mechanism;

FIG. 9 is a frontal view of a rotation motor incorporated in the clamp mechanism;

FIG. 10 shows, using a plane view, a section view and a frontal view, a first type of chuck claw employed by the clamp mechanism; and

FIG. 11 shows, using a plane view, a section view and a frontal view, a second type of chuck claw employed by the clamp mechanism.

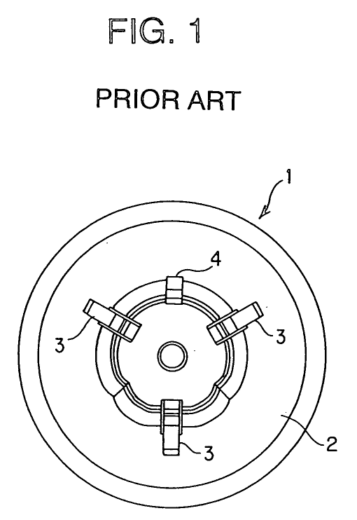

### DETAILED DESCRIPTION OF PREFERRED EMBODIMENT

Refereeing to the accompanying drawings, a preferred embodiment of the present invention will now be described. In the following, a disk reproducing apparatus employed as an information reproducing apparatus of the present invention will be described. The disk reproducing apparatus, which adopts therein a clamp mechanism according to the present invention, is configured to reproduce bits of information recorded on information recording mediums such as CDs and DVDs (hereafter simply referred to as disks).

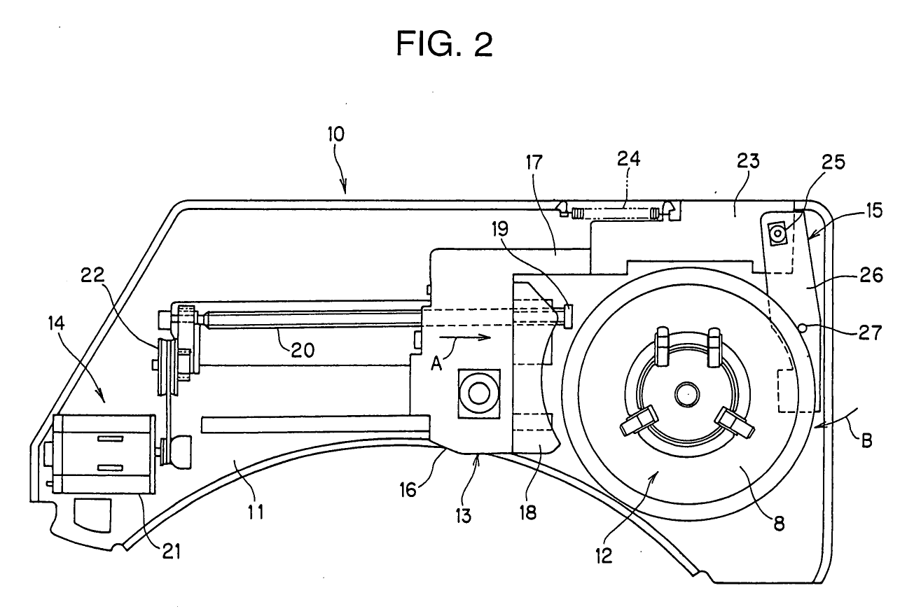

FIG. 2 shows a plane view of the disk reproducing apparatus with the clamp mechanism configured in accordance with the present invention. As shown in FIG. 2, the disk reproducing apparatus 10 has a movable base 11, on which a turntable 12, pickup 13, pickup moving mechanism 14, and clamp controlling mechanism 15 are mounted. The turntable 12 is shaped into a disk-like member and has a loading plane on which a disk 8 can be loaded.

The pickup 13 is provided with a securing base 16 formed to have an approximately L-shaped side. A pressing protrusion 17 is integrally formed on one side of the securing base 16, in which the one side faces the turntable. Additionally, on the one side of the securing base 16, an operating member 18 is fixed.

The pickup moving mechanism 14 is provided with a screw shaft 20 whose one end is supported by a support member 19. Further, the pickup moving mechanism 14 is provided with a drive motor 21 and a drive-force transmission mechanism 22 including pulleys and belts to transmit a drive force generated by the drive motor 21 to the screw shaft 20.

The clamp controlling mechanism 15 includes a movement member 23, a coil spring 24, and an operation lever 26. Of these components, the movement member 23 is pressed by the pressing protrusion 17 formed on the securing base 16 of the pickup 13. The coil spring 24 forces the movement member 23 downward in the drawing of FIG. 2. The operation lever 26 is rotatably connected with the movement member 23 via a connection shaft 25, so that the operation lever 26 is able to turn around a support shaft 27.

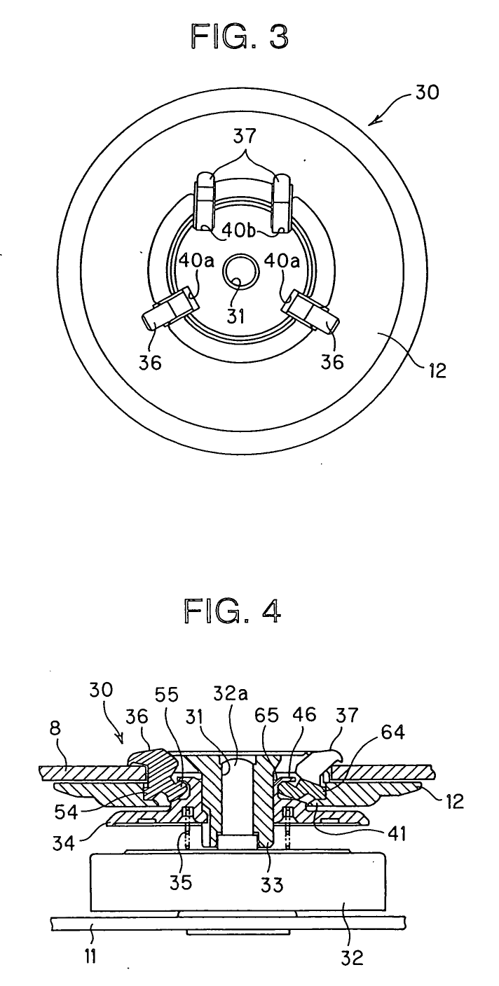

FIGS. 3 to 6 show a clamp mechanism 30 that essentially comprises a rotation motor 32, a movable member 34, a spring 35, and a plurality of types of chuck claws 36 and 37.

The rotation motor 32 serves as a rotation driving device mounted and its rotation shaft 32a is inserted into a shaft-inserting perforation 31 of the turntable 12. The movable member 34 fixedly accepts a cylindrical portion 33 of the turntable 12 and is slidable in a direction perpendicular to the loading plane (i.e., disk-loading plane) of the turntable 12 (that is, the movable member 34 is slidable in the up-and-down direction in FIGS. 4 to 6). Further, the spring 35 intervenes between the movable member 34 and the rotation motor 32, with the result that the movable member 34 is forced upward.

The chuck claws 36 and 37 are, for example, as shown in FIG. 3, composed of two types of chuck claws, both of which function as the holders according to the present invention.

A first type of holder is composed of two chuck claws 36 arranged to partly emerge above the loading plane of the turntable 12 and to clamp the disk 8 loaded on the loading plane. Thus, the disk 8 can be held on the loading plane by the chuck claws 36. A second type of holder is also composed of a single chuck claw 37 arranged to partly emerge above the loading plane of the turntable 12 at two circumferential potions and to press the disk 8 in a direction parallel to the loading plane. As can be understood from FIGS. 3 and 11, the chuck claw 37 is produced into a single body having two tip portions emerging and submerging above and below the loading plane of the turntable 12. Hence the disk 8 can be aligned on the loading plane by the chuck claw 37 concurrently with the hold operations carried out the first type of chuck claws 36.

As comprehensive from FIG. 3, the first type of two chuck claws 36 and 36 and an angular central position of the two tip portions of the second type of chuck claw 37 (that is, the three positions) are arranged to locate equal angular intervals of 120 degrees around the center of the turntable 12.

The turntable 12 is thus able to rotate responsively to the rotation of the rotation shaft 32a of the motor 32, and both of the movable member 34 and the spring 35 rotate together in response to the rotation the turntable 12.

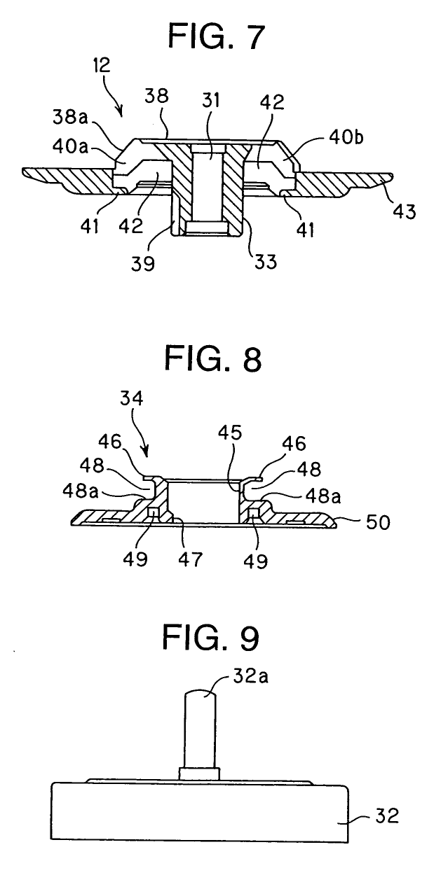

As shown in FIG. 7, the turntable 12 is formed so that it has a cylindrical portion 33 integrally formed with the turntable 12 to protrude from the center of the lower surface of the turntable 12. The shaft-inserting perforation 31 is formed through the cylindrical portion 33 and, as shown in FIG. 9, the rotation shaft 32a of the motor 32 is fit into the perforation 31. On the other hand, on the upper surface of the turntable 12 is formed a circular stepped portion 38 continuing to a sloped surface 38a onto which the central opening of the disk 8 is applied.

As shown in FIG. 7, on the outer circumferential surface of the cylindrical portion 33, plural longitudinal grooves 39, each serving as a guide member, are formed in the axial direction of the cylindrical portion 33. Furthermore, in a space ranging from the stepped portion 38 of the turntable 12 to the bottom thereof, as shown in FIG. 3, four claw-loaded spaces 40a, 40a, 40b and 40b used for accommodating the chuck claws 36, 36, and 37 are individually formed at four spots located at appropriately selected intervals around the circular stepped portion 38. Of these four claw-loaded spaces 40a, 40a, 40b and 40b, the two claw-loaded spaces 40a and 40a are able to accommodate the first type of two chuck claws 36 and 36, respectively, while the two claw-loaded spaces 40b and 40b are able to accommodate the two tip portions of the second type of chuck claw 37, respectively. At the position corresponding to the bottom of each of the claw-loaded spaces 40a, 40a, 40b and 40b, a supporting protrusion 41 to support each chuck claw 36 (37) is integrally formed with the turntable 12 so that it protrudes radial-inward from the turntable 12.

A circular stepped recess 42 that can accept the movable member 34 is formed on the bottom, other than the four claw-loaded spaces 40a, 40a, 40b and 40b, of the stepped portion 38. Around the stepped portion 38, a tapered flange 43 is also formed integrally with the stepped portion 38. The lower surface of the tapered flange 43 is shaped to be ascendant outwardly in the radial direction thereof.

FIG. 8 shows in detail the movable member 34 having a cylindrical body 45 at a central portion of the member 34. On the upper end of the cylindrical body 45, four pressing protrusions 46 are integrally formed with the body 45 so that they protrude outwardly in the radial direction of the body 45. These pressing protrusions 46 press the lower ends of the plural chuck claws 36, 36 and 37 downward when the movable member 34 is driven to slide in the downward direction going away from the turntable 12. This pressing operation enables the chuck claws 36, 36 and 37 to forcibly rotate in a direction permitting the disk 8 to be released from its hold on the turntable 12. The direction corresponds to a downward direction submerging below the loading plane of the turntable 12 (hereafter, as occasion demands, referred to as an “unclamping direction”). Thus, the chuck claws 36, 36 and 37 can be prevented from rotating in an upward direction emerging above the loading plane of the turntable 12 (hereafter, as occasion demands, referred to as a “clamping direction”).

Due to some reasons, it may be caused that the chuck claws 36, 36 and 37 once driven down to their predetermined lowest positions in the unclamping direction are tried to be driven in the clamping direction. If such a situation may happen, a rotational motion of each of the chuck claws 36, 36 and 37 in the clamping direction is surely prohibited, because the lower end of each chuck claw 36 (37) is pressed downward.

The foregoing operating member 18, operation lever 26, movable member 34, spring 35, and pressing protrusions 46 are employed to substantially compose the driving device of the present invention.

As shown in FIG. 8, on the inner circumferential lower end of the cylindrical body 45, plural projections 47 also functioning as guide members are formed integrally with the body so that they project inward in the radial direction of the cylindrical body 45. Each of these projections 47 is configured to be fit into each of the grooves 39, also functioning as the guide members, formed on the outer circumferential surface of the cylindrical portion 33 of the turntable 12, respectively. Thus, the movable member 34 is slidable longitudinally along the cylindrical portion 33 in a guided manner.

Furthermore, as shown in FIG. 8, below the pressing protrusions of the cylindrical body 45, there are continuously formed engaging recesses 48 to engage with the lower end portions of the chuck claws 36, 36 and 37 and contact surfaces 48a to come in contact with such lower end portions. In addition, a circular retaining groove 49 to retain one end of the spring 35 is formed at a given radial position on the bottom surface of the cylindrical body 45. The cylindrical body 45 is also integrally coupled with a ring-like tapered flange 50 located around the body 45, as shown in FIG. 8. The tapered flange 50 has an upper surface including an end surface descending outwardly in the radial direction thereof.

On the other hand, as shown in FIGS. 3 to 6, each of the first type of chuck claws 36 is loaded rotatably in each of the two claw-loaded spaces 40a formed in the turntable 12. Each chuck claw 36 is permitted to partly emerge or entirely submerge above or below the loading plane of the turntable 12 by making the movable member 34 slide along the cylindrical portion 33 of the turntable 12. These emerging and submerging operations, that is, clamping and unclamping operations, make it possible to detachably mount the disc 8 on the turntable 12. When being emerged above the loading plane, each chuck claw 36 is able to clamp the disk 8 on the loading plane in a releasable manner. During each of such emerging and submerging operations, the lower end portion of each chuck claw 36 is held by each supporting protrusion 41 of the turntable 12 and each engaging recess 48 of the movable member 34.

The second types of chuck claw 37 are, as shown in FIGS. 3 to 6, loaded in a rotatable manner in the two claw-loaded spaces 40b formed in the turntable 12, respectively. The chuck claw 37 is permitted to partly emerge or entirely submerge above or below the loading plane of the turntable 12 by making the movable member 34 slide along the cylindrical portion 33 of the turntable 12. When partly emerging above the loading plane, an upper end of the chuck claw 37 is able to press the disk 8 in the horizontal direction parallel to the loading plane. At this time, a lower end of the chuck claw 37 is held by each supporting protrusion 41 of the turntable 12 and each engaging recess 48 of the movable member 34.

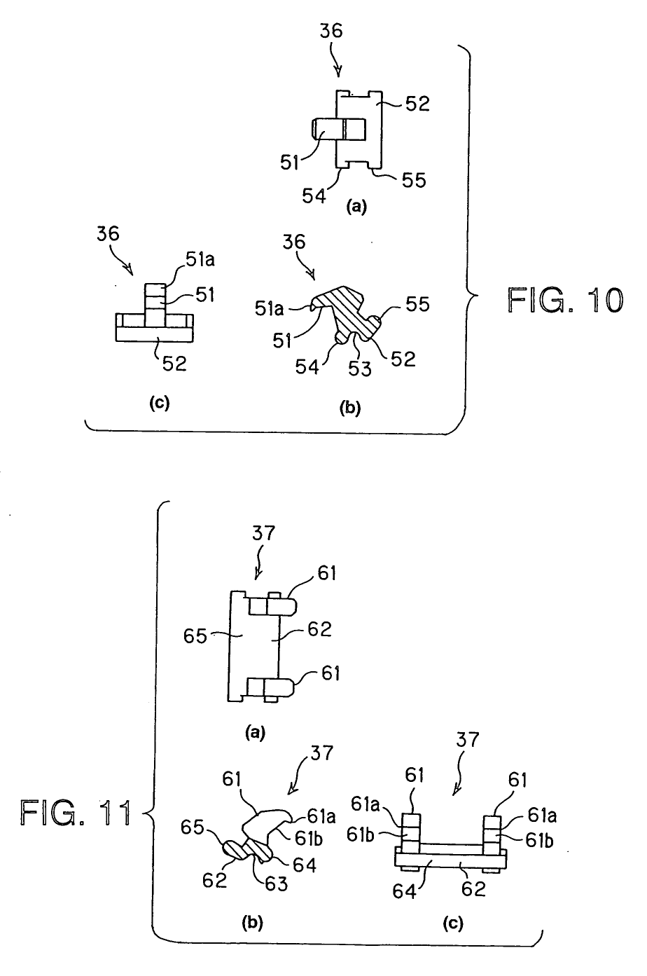

FIG. 10 shows, using a plane view, a section view and a frontal view, each of the first type of chuck claws 36 employed by the clamp mechanism.

As shown in FIG. 10, each of the first type of chuck claws 36 is made of, for example, synthetic resin and produced as an integral member. Each chuck claw 36 has a hook-shaped body 51 on its one end side, in which the body 51 further has at its tip a holding tip 51a formed into an approximate wedge shape in section. Whenever the movable member 34 moves upward to be located at a predetermined higher position (refer to FIG. 4), the hook-shaped body 51 is forced to appear from, that is, emerge above the loading plane of the turntable 12. This protrusion of the body 51 enables its holding tip 51a to clip the upper surface of the disk 8 on the turntable 12.

The other end side of each chuck claw 36 is formed as a base 52 shaped into a substantially rectangular plate-like form. On the bottom surface of the base 52 is formed a bottomed recess 53 into which each supporting protrusion 41 of the turntable 12 can be fit, when the movable member 34 is located at a predetermined lower position (refer to FIG. 6). Further, on the frontal side of the base 52 is formed an engaging protrusion 55 that can be fit into each engaging recess 48 of the movable member 34 so that the engaging protrusion 55 comes into contact with each contact surface 48a.

Thus, each chuck claw 36 is configured such that one side thereof can be rotated about a support protrusion 54 formed at one end of the base 52. On the other end opposing the one side, an engaging protrusion 55 is formed. Accordingly, the engaging protrusion 55 is configured such that it is pressed by each pressing protrusion 46 of the movable member 34.

FIG. 11 shows, using a plane view, a section view and a frontal view, each of the second type of chuck claw 37 employed by the clamp mechanism 30.

As shown in FIG. 11, the second type of chuck claw 37 is made of, for example, synthesis resin and produced as an integral member. The chuck claw 37 has two claw pieces 61 at its one end (tip portions described before), and the tip of each claw piece 61 is made to have a holding piece 61a formed into a hook-like shape in section. Each claw piece 61 has a lower surface formed as a slope surface 61b. When the movable member 34 is located at the predetermined higher position as shown in FIG. 4, the holding pieces 61a of each claw piece 61 are made to emerge in part above the loading plane of the turntable 12 from each claw-loaded space 40b. Concurrently, in the case that the movable member 34 is located at the predetermined higher position, each claw piece 61 is driven such that its slope surfaces 61b press the side wall of the central opening of the disk 8 in an oblique downward direction. This pressing operation creates a component force that can be dissolved in the rightward and downward directions in FIG. 4. Such a component force enables the disk 8 to be pushed in a parallel direction to the loading plane of the disk 8, whereby the chuck claw 37 is able to position the disk 8 together with the chuck claws 36, with the alignment performed. The downward component force contributes to hold the disk 8, so that the chuck claw 37 also serves as the holder according to the invention.

The other end side of the chuck claw 37 is formed as a base 62 shaped into a substantially rectangular plate-like form. The base 62 thus connects the two claw pieces 61 corresponding to the tip portions that emerge or submerge from the loading plane of the turntable 12. On the bottom surface of the base 62 is formed a bottomed recess 63 into which each supporting protrusion 41 of the turntable 12 can be fit, when the movable member 34 is located at a predetermined lower position (refer to FIG. 6). Further, on the frontal side of the base 62 is formed an engaging protrusion 65 that can be fit into each engaging recess 48 of the movable member 34 so that the engaging protrusion 65 comes into contact with each contact surface 48a.

Thus, the chuck claw 37 is configured such that one side thereof can be rotated about a support protrusion 64 formed at one end of the base 62. On the other end opposing the one side, an engaging protrusion 65 is formed. Accordingly, the engaging protrusion 65 is configured such that it is pressed by each pressing protrusion 46 of the movable member 34.

The operations of the clamp mechanism 30 according to the present embodiment will now be described.

When the disk reproducing apparatus 10 is in operation with the disk 8 clamped on the turntable 12, the clamp mechanism 30 is brought into a state shown in FIG. 4. Namely, the chuck claws 36 and 37 protrude above the loading plane of the turntable 12.

Hence, the disk 8 on the turntable 12 can be held by the first type of chuck claws 36 in a secure fashion.

Concurrently with the above holding operation, the slope surfaces 61b of the two claw pieces of 61 of the chuck claw 37 press the side wall of the central opening of the disk 8 in an oblique downward direction, thus creating component forces that can be dissolved in the rightward and downward directions in FIG. 4. This component forces enable the disk 8 to be pushed in a parallel direction to the loading plane of the disk 8. Therefore, the chuck claw 37 is able to give a centering operation to both of the disk 8 and the chuck claws 36, whereby the alignment can be performed.

(Unclamping Operation)

In cases where an operator issues a command to eject the disk 8, the disk reproducing apparatus 10 begins starting releasing the clamped state of the disk 8 responsively to the issued command. First, the motor 21 is driven to rotate, in which a generated drive force is transmitted to the screw shaft 20 via the drive-force transmission mechanism 22, resulting in that the screw shaft 20 is forcibly rotated. The rotation of the screw shaft 20 allows the pickup 13 to move in the direction A in FIG. 2, so that both of the pressing protrusion 17 and the operating member 18 travel in the same direction A responsibly to the move of the pickup 13.

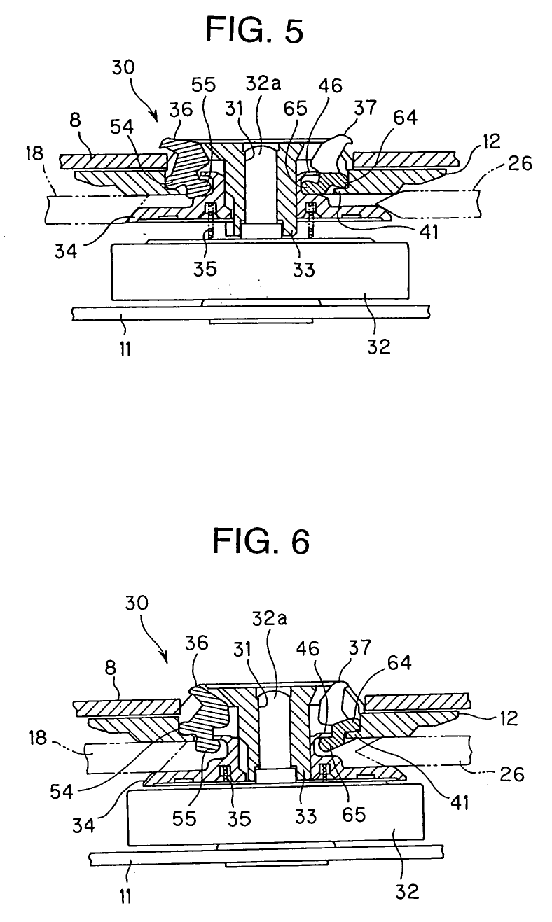

The travel of the operating member 18 will cause the movement member 23 to move in the direction toward the turntable 12 against a repelling force of the coil spring 24. In response to the travel of the operating member 18, the operation lever 26 connected to the connection shaft 25 is forced to rotate around the support shift 27 in the direction B shown in FIG. 2. Thus, via a transient state shown in FIG. 5, a state shown in FIG. 6 is realized, where both of the operation lever 26 and the operating member 18 are forcibly inserted into a space formed between the turntable 12 and the movable member 34, thereby pushing up the movable member 34.

As the movable member 34 moves downward responsively to the insertions of both of the operation lever 26 and the operating member 18, the pressing protrusions 46 of the member 34 push down the engaging protrusion 55 of each chuck claw 36. In response to this, each chuck claw 36 is forcibly rotated clockwise in FIGS. 5 and 6 around the support protrusion 54 (i.e., a fulcrum) of the base 52 supported by each supporting protrusion 41 of the turntable 12. This rotation responsibly causes the hook-shaped body 51 to retract (submerge) below the loading plane of the turntable 12 so as to return to each claw-loaded space 40a. Accordingly, the clamped state of the disk 8 can be released.

Concurrently with the above operations, the second type of chuck claw 37 will operate as follows. As the movable member 34 moves downward responsively to the insertions of both of the operation lever 26 and the operating member 18, the pressing protrusions 46 of the member 34 push down the engaging protrusion 65 of the chuck claw 37. In response to this, the chuck claw 37 is forcibly rotated counterclockwise in FIGS. 5 and 6 around the support protrusion 64 (i.e., a fulcrum) of the base 62 supported by each supporting protrusion 41 of the turntable 12. This rotation responsibly causes the two claw pieces 61 to retract (submerge) below the loading plane of the turntable 12 so as to return to each claw-loaded stapes 40b. Accordingly, the clamped state of the disk 8 can be released.

(Clamping Operation)

On the other hand, both the operating member 18 and the operation lever 26 are driven to retract so that the movable member 34 is released from its pressed state, the movable member 34 moves upward in response to a repelling force of the spring 35. Thus, the engaging protrusion 55 of each chuck claw 36 is pressed onto the contact surface 48a of the movable member 34. Hence each chuck claw 36 is forced to rotate counterclockwise in FIGS. 5 and 6 around the support protrusion 54 serving as the fulcrum, resulting in that the hook-shaped body 51 is forcibly made to emerge above the loading plane of the turntable 12. Accordingly, the disk 8 can be clamped steadily by the holding tips 51a of the chuck claws 36.

The similar operation can be performed by the second type of chuck claw 37, concurrently with the above operation performed by the first type of chuck claws 36. That is, as the movable member 34 moves upward as stated above, the engaging protrusion 65 of the chuck claw 37 is pressed onto the contact surface 48a of the movable member 34. Hence the chuck claw 37 is forced to rotate, as a whole, clockwise in FIGS. 5 and 6 around the support protrusion 64 serving as the fulcrum, resulting in that the holding pieces 61a of each claw piece 61 are forcibly made to emerge above the loading plane of the turntable 12.

Accordingly, the slope surfaces 61b of the holding pieces 61a of the chuck claw 37 are able to apply the foregoing component forces to the side wall, at the two side positions thereof, of the central opening of the disk 8, whereby the disk 8 can be pushed in the parallel direction to the loading plane. The disk 8 can therefore be subjected to a centering operation together with the first type of chuck claws 36 in the horizontal direction, with the alignment realized.

The present embodiment configured as described above provides the following various advantages.

The clamp mechanism 30 according to the present embodiment is provided with the two types of chuck claws 36, 36 and 37, of which the second types of chuck claw 37 (corresponding to “the at least one chuck claw” of the present invention) are configured to press the disk 8 loaded on the loading plane of the turntable 12 in the horizontal direction to the loading plane. Hence, there is no spring dedicated to the alignment, thus reducing the number of parts of the clamp/alignment mechanism, thus simplifying the structure thereof. Even so, the disk 8 can be held on the loading plane of the turntable 12 and can be aligned as well.

Further, the plural chuck claws 36, 36 and 37 operate cooperatively and simultaneously to not only hold the disk 8 but also press the disk 8 in an oblique downward direction (but in effect, in the horizontal direction to the loading plane with a downward component force applied to the disk 8, because there is the loading plane). This way permits the disk to be held steadily and aligned in a sure manner without dedicated aligning parts, unlike the conventional.

Still further, the clamp mechanism 30 is provided with the movable member 34 being slidable in the perpendicular direction to the loading plane of the turntable 12 and having the pressing protrusion 36 pressing the plural chuck claws 36, 36 and 37 so as to release the held disk 8 when movable member 34 is made to slide down to be away from the turntable 12. This configuration assures that a clamped disk 8 is forcibly released (unclamped) in a steady manner, irrespective of what attitude the clamped disk to be subjected to the unclamping operation takes.

In addition, the first type of chuck claw 37 has the two claw pieces 61 (tip portions) that individually press the disk 8 for primarily the alignment. The central position between the two claw pieces 61 is set to be angularly equal to both of the two chuck claws 36. A combination of t his angularly three-divided, but balanced arrangement as well as the two-claw-piece structure provides a smooth and steady alignment operation.

For securing the movable member 34 to the turntable 12, the plural projections 47 built on the inner surface of the cylindrical body 45 of the movable member 34 are forcibly fit into the plural grooves 39 formed on the cylindrical portion 33 of the turntable 12. The movable member 34 can therefore be guided in its sliding motions in a smooth and secure manner.

Moreover, the turntable 12 has the tapered flange 43 therearound and the flange 43 has the lower surface descending partly in the outward direction. In contrast, the movable member 34 has the tapered flange 50 therearound in such a manner that the flange 50 has the upper surface ascending partly in the outward direction. It is therefore possible that both the operating member 18 and the operation lever 26 can be forcibly inserted between the turntable 12 and the movable member 34 in a reliable manner, with the movable member 34 slid, and then the clamped state released steadily.

Since the disk reproducing mechanism 10 has the clamp mechanism 30 described above, the disk reproducing mechanism 10 is also entitled to have the foregoing various advantages, such as making it possible to hold and align a disk, under the condition that the number of parts of the clamp mechanism 30 is reduced for a simplified configuration.

The present invention may be embodied in other specific forms without departing from the spirit or essential characteristics thereof. The present embodiments are therefore to be considered in all respects as illustrative and not restrictive, the scope of the present invention being indicated by the appended claims rather than by the foregoing description and all changes which come within the meaning and range of equivalency of the claims are therefore intended to be embraced therein.

The entire disclosure of Japanese Patent Application No. 2002-349550 filed on Dec. 2, 2002 including the specification, claims, drawings and summary is incorporated herein by reference in its entirety.

What is claimed is:

1. A clamp mechanism for clamping and unclamping an information recording medium to be loaded on a loading plane of a turntable, the clamp mechanism comprising:
a plurality of holders each holding the information recording medium loaded on the loading plane of the turntable; and
a driving device driving the holders in both of a holding direction along which the information recording medium is held and an un-holding direction along which the information recording medium is released from being held;
wherein at least one of the plurality of holders is configured to press, in a direction parallel to the loading plane, the information recording medium loaded on the turntable.

2. The clamp mechanism according to claim 1, wherein the plurality of holders are configured to simultaneously hold and press the information recording medium when the driving device is driven in the holding direction.

3. The clamp mechanism according to claim 1, wherein the driving device comprises a movable member slidable in a direction perpendicular to the loading plane of the turntable, and
a pressing member pressing the plurality of holders so as to release the information recording member from being held, when the movable member is slid in the direction perpendicular to the loading plane to be separated from the loading plane.

4. An information reproducing mechanism comprising:
a turntable having a loading plane on which an information recording medium is allowed to be loaded; and
a clamp mechanism for clamping and unclamping the information recording medium loaded on the loading plane of the turntable, the clamp mechanism comprising:
a plurality of holders each holding the information recording medium on the turntable; and
a driving device driving the holders in both of a holding direction along which the information recording medium is held and an un-holding direction along which the information recording medium is released from being held;
wherein at least one of the plurality of holders is configured to press, in a direction parallel to the loading plane, the information recording medium loaded on the turntable.

5. The information reproducing mechanism according to claim 4, wherein the plurality of holders are configured to simultaneously hold and press the information recording medium when the driving device is driven in the holding direction.

6. The information reproducing mechanism according to claim 4, wherein the driving device comprises a movable member slidable in a direction perpendicular to the loading plane of the turntable, and
a pressing member pressing the plurality of holders so as to release the information recording member from being held, when the movable member is slid in the direction perpendicular to the loading plane to be separated from the loading plane.
